(19) United States
(12) Patent Application Publication
(10) Pub. No.: US 2026/0071612 A1
(43) Pub. Date: Mar. 12, 2026

(54) ACTIVE COOLING FEEDBACK LOOP FOR ACTUATOR WITH CONTRACTING MEMBER

(71) Applicant: Toyota Motor Engineering & Manufacturing North America, Inc., Plano, TX (US)

(72) Inventors: Michael Paul Rowe, Pinckney, MI (US); Erin J. Rutledge, Tipton, MI (US)

(73) Assignees: Toyota Motor Engineering & Manufacturing North America, Inc., Plano, TX (US); Toyota Jidosha Kabushiki Kaisha, Toyota-shi (JP)

(21) Appl. No.: 19/326,000

(22) Filed: Sep. 11, 2025

Related U.S. Application Data
(60) Provisional application No. 63/693,656, filed on Sep. 11, 2024.

(51) Int. Cl. F03G 7/06

(52) U.S. Cl. CPC F03G 7/06143; F03G 7/066

(57) ABSTRACT

An actuator can include a contracting member. The can be actuator configured to morph, when the contracting member is activated, into an activated configuration in which a dimension of the actuator increases. When the actuator is in an activated configuration, a supply of energy to the contracting member can be discontinued. The contracting member can be caused to be actively cooled. A state of the contracting member can be monitored.

### CROSS-REFERENCE TO RELATED APPLICATIONS

This application claims the benefit of U.S. Provisional Application No. 63/693,656, filed on Sep. 11, 2024, which is incorporated herein by reference in its entirety.

### FIELD

The subject matter described herein relates in general to actuators and, more particularly, to actuators that include a contracting member.

### BACKGROUND

Shape memory alloys change shape when an activation input is provided to the material. When the activation input is discontinued, the material returns to its original shape. Shape memory alloys are used in some actuator designs.

### BRIEF DESCRIPTION OF THE DRAWINGS

FIG. 1 is an example of an actuator, showing a non-activated configuration.

FIG. 2 is an example of the actuator of FIG. 1, showing an activated configuration.

FIG. 3 is an example of a system.

FIG. 4 is an example of a method.

FIG. 5 is an example of a cooling feedback loop.

### DETAILED DESCRIPTION

There are various actuators that use shape memory alloy (SMA) wires or other contracting members as the actuation mechanism. When an activation input is provided to the SMA wire, the SMA wire is heated, which causes the wire to contract. When deactivated, the activation input is discontinued, causing the wire to cool. When the wire cools beyond its transition temperature, the wire can relax.

It is desirable to prevent overcooling of the SMA wire or other contracting member. When an SMA wire overcools, it requires more power or other activation input to re-activate the SMA wire. Accordingly, arrangements described herein are directed to monitoring the state of the SMA wire to prevent overcooling.

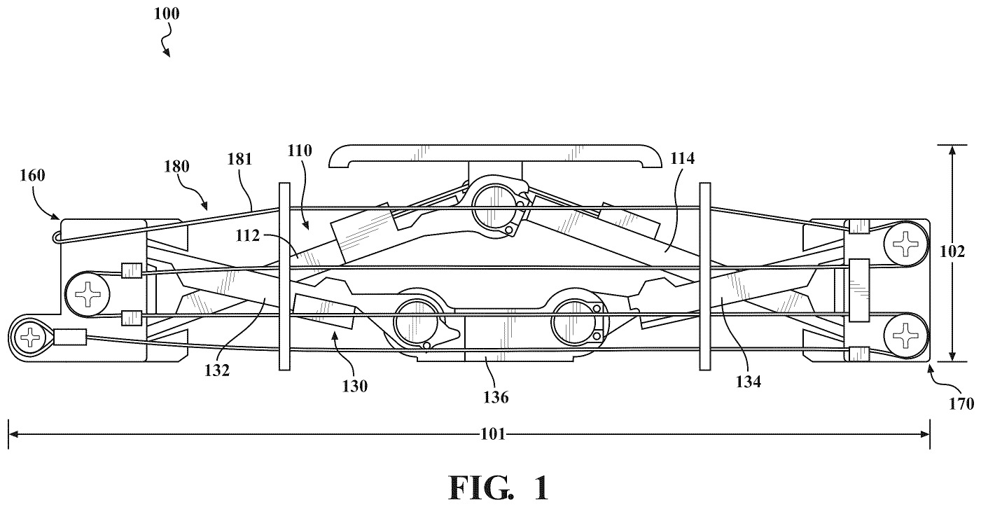

Detailed embodiments are disclosed herein; however, it is to be understood that the disclosed embodiments are intended only as examples. Therefore, specific structural and functional details disclosed herein are not to be interpreted as limiting, but merely as a basis for the claims and as a representative basis for teaching one skilled in the art to variously employ the aspects herein in virtually any appropriately detailed structure. Further, the terms and phrases used herein are not intended to be limiting but rather to provide an understandable description of possible implementations. Various embodiments are shown in FIGS. 1-5, but the embodiments are not limited to the illustrated structure or application.

An actuator can include one or more contracting members. The contracting member(s) can be any structure or material that, when activated, is configured to shrink in at least one dimension (e.g., length).

In one or more arrangements, the contracting member(s) can be one or more shape memory material members, one or more active material members, or one or more memory material members. For convenience, the following description will be made in connection with the contracting member being a shape memory material member. However, it will be understood that the contracting member is not limited to being a shape memory material member.

The phrase “shape memory material” includes materials that changes shape when an activation input is provided to the shape memory material and, when the activation input is discontinued, the material substantially returns to its original shape. Examples of shape memory materials include shape memory alloys (SMA) and shape memory polymers (SMP).

In one or more arrangements, the shape memory material members can be shape memory material wires. As an example, the shape memory material members can be shape memory alloy wires. Thus, when an activation input (i.e., heat) is provided to the shape memory alloy wire(s), the wire(s) can contract. Shape memory alloy wire(s) can be heated in any suitable manner, now known or later developed. For instance, shape memory alloy wire(s) can be heated by the Joule effect by passing electrical current through the wires. In some instances, arrangements can provide for cooling of the shape memory alloy wire(s), if desired, to facilitate the return of the wire(s) to a non-activated configuration. Of course, it will be appreciated that the activation input can be provided to the shape memory alloy wire(s) in other ways. For example, heated air can be blown on the shape memory alloy wire(s).

The wire(s) can have any suitable characteristics. For instance, the wire(s) can be high temperature wires with austenite finish temperatures from about 80 degrees Celsius to about 110 degrees Celsius. The wire(s) can have any suitable diameter. For instance, the wire(s) can be from about 0.2 millimeters (mm) to about 0.7 mm, from about 0.3 mm to about 0.5 mm, or from about 0.375 millimeters to about 0.5 millimeters in diameter. In some arrangements, the wire(s) can have a stiffness of up to about 70 gigapascals. The pulling force of SMA wire(s) can be from about 150 MPA to about 400 MPa. The wire(s) can be configured to provide an initial moment of from about 300 to about 600 N·mm, or greater than about 500 N·mm, where the unit of newton millimeter (N·mm) is a unit of torque (also called moment) in the SI system. One newton meter is equal to the torque resulting from a force of one newton applied perpendicularly to the end of a moment arm that is one meter long. In various aspects, the wire(s) can be configured to transform in phase, causing the shape memory material members to be moved from non-activated position to an activated position in about 3 seconds or less, about 2 seconds or less, about 1 second or less, or about 0.5 second or less.

The wire(s) can be made of any suitable shape memory material, now known or later developed. Different materials can be used to achieve various balances, characteristics, properties, and/or qualities. As an example, an SMA wire can include nickel-titanium (Ni-Ti, or nitinol). One example of a nickel-titanium shape memory alloy is FLEXINOL, which is available from Dynaolloy, Inc., Irvine, California. As a further example, the SMA wires can be made of Cu-Al-Ni, Fe-Mn-Si, or Cu-Zn-Al.

The SMA wire can be configured to increase or decrease in length upon changing phase, for example, by being heated or cooled to a phase transition temperature T_{SMA}. Utilization of the intrinsic property of SMA wires can be accomplished by using heat, for example, via the passing of an electric current through the SMA wire in order provide heat generated by electrical resistance, in order to change a phase or crystal structure transformation (i.e., twinned martensite, detwinned martensite, and austenite) resulting in a lengthening or shortening the SMA wire. In some implementations, during the phase change, the SMA wire can experience a decrease in length of from about 2 to about 8 percent, or from about 3 percent to about 6 percent, and in certain aspects, about 3.5 percent, when heated from a temperature less than the T_{SMA} to a temperature greater than the T_{SMA}.

Other active materials may be used in connection with the arrangements described herein. For example, other shape memory materials may be employed. Shape memory materials, a class of active materials, also sometimes referred to as smart materials, include materials or compositions that have the ability to remember their original shape, which can subsequently be recalled by applying an external stimulus, such as an activation signal.

While the shape memory material members are described, in some implementations, as being wires, it will be understood that the shape memory material members are not limited to being wires. Indeed, it is envisioned that suitable shape memory materials may be employed in a variety of other forms, such as sheets, plates, panels, strips, cables, tubes, or combinations thereof. In some arrangements, the shape memory material members may include an insulating coating.

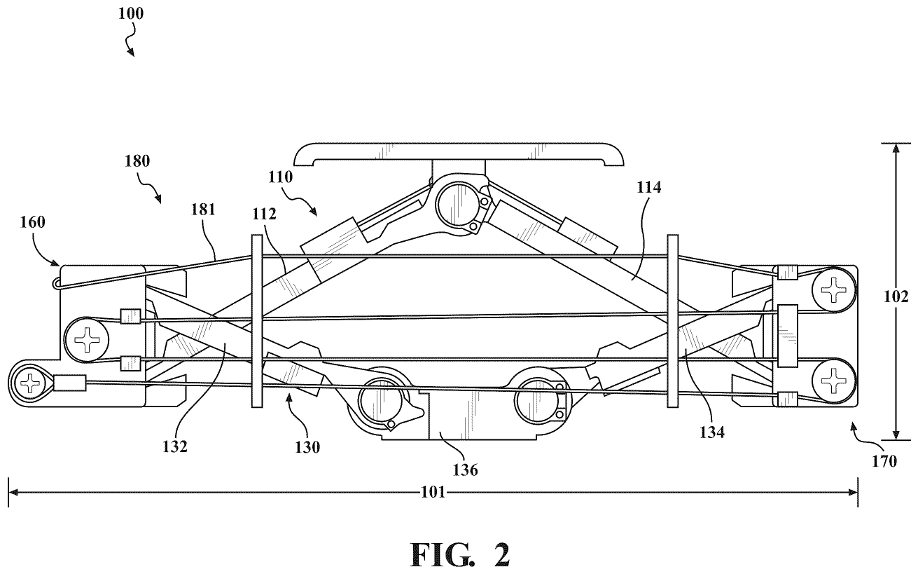

FIGS. 1-2 show one example of an actuator 100 suitable for use according to arrangements herein. The basic details of the actuator 100 will now be described. Additional details of the actuator 100 are described in U.S. Pat. No. 12,241,458, which is incorporated herein by reference in its entirety.

The actuator 100 can include a first outer body member 110, a second outer body member 130, a first endcap 160, a second endcap 170, and a contracting member 180, which can be a shape memory material member 181. The first outer body member 110 can include a first portion 112 and a second portion 114. The first portion 112 and the second portion 114 can be operatively connected to each other such that the first portion 112 and the second portion 114 can move relative to each other. In one or more arrangements, the first portion 112 and the second portion 114 can be pivotably connected to each other. For example, the first portion 112 and the second portion 114 can be pivotably connected to each other by one or more hinges. The first portion 112 and the second portion 114 can be angled relative to each other. As a result, the first outer body member 110 can have a generally V-shape.

The second outer body member 130 can include a first portion 132, a second portion 134, and a base 136. In one or more arrangements, each of the first portion 132 and the second portion 134 can be pivotably connected to the base 136. For example, the first portion 132 can be pivotably connected to the base 136 by one or more hinges, and the second portion 134 can be pivotably connected to the base 136 by one or more hinges. The first portion 132 and the second portion 134 can be located on opposite sides of the base 136.

The first outer body member 110 the second outer body member 130 can be arranged in a scissored configuration. In one or more arrangements, a portion of the first outer body member 110 can cross a portion of the second outer body member 130. More particularly, the first portion 112 of the first outer body member 110 and the first portion 132 of the second outer body member 130 can cross each other. Alternatively or additionally, the second portion 114 of the first outer body member 110 and the second portion 134 of the second outer body member 130 can cross each other. In one or more arrangements, the first portion 112 of the first outer body member 110 can pass through the first portion 132 of the second outer body member 130 and/or the second portion 114 of the first outer body member 110 can pass through the second portion 134 of the second outer body member 130. Of course, it will be appreciated that, in other arrangements, the first portion 132 of the second outer body member 130 can pass through the first portion 112 of the first outer body member 110 and/or the second portion 134 of the second outer body member 130 can pass through the second portion 114 of the first outer body member 110.

The actuator 100 can include a first endcap 160 and a second endcap 170. The first endcap 160 and the second endcap 170 can be spaced apart. The actuator 100 can include one or more contracting member(s) 180 (e.g., one or more shape memory material members 181). The contracting member(s) 180 can extend between the first endcap 160 and the second endcap 170 in any suitable manner. The contracting member(s) 180 can be operatively connected to the first endcap 160 and the second endcap 170.

FIG. 1 shows an example of the actuator 100 in a non-activated configuration. Here, the contracting member(s) 180 are not activated. When activated, the actuator is configured to morph into an activated configuration in which a dimension of the actuator increases. FIG. 2 shows an example of the actuator 100 in an activated configuration. When an activation input (e.g., e.g., energy, heat, electrical energy, current, etc.) is provided to the contracting member(s) 180, the contracting member(s) 180 can contract. This contraction can cause the contracting member(s) 180 to pull the first endcap 160 and the second endcap 170 toward each other in a direction that corresponds to the first dimension 101. As a result, the first outer body member 110 and the second outer body member 130 can extend outward and away from each other in a direction that corresponds to the second dimension 102. It will be appreciated that, in going from the non-activated condition to the activated condition, the first dimension 101 (i.e., the width) of the actuator 100 can decrease and/or the second dimension 102 (i.e., the height) of the actuator 100 can increase. Further, it will be appreciated that the actuator 100 can deliver a force in a direction that is out of plane or otherwise different from the direction of contraction of the contracting member(s) 180.

Again, the actuator 100 shown in FIGS. 1-2 is merely one example of a suitable actuator in accordance with arrangements described herein and is not intended to be limiting. This and other actuators are described in U.S. Patent Publication No. 12,241,458, which is incorporated herein by reference in its entirety. Other actuators are described in U.S. Pat. Nos. 10,960,793; 11,370,330; 11,285,844; 11,091,060; 11,603,828; 11,752,901; 11,897,379; 12,152,570; 12,163,507; 12,270,386; and 12,383,066, which are incorporated herein by reference in their entireties. Additional non-limiting examples of actuators are described in U.S. Patent Publication Nos. 2023/0191953; 2023/0136197; 2025/0172130; 2025/0058679; 2025/0058688; 2025/0065787; 2025/0065777; 2025/0092862; and 2025/0214265, which are incorporated herein by reference in their entireties. Still further actuators are described in U.S. Patent Application Nos. 63/850,102 and 63/623,930, which are incorporated herein by reference in their entireties. Arrangements described herein can be used in connection with any of the actuators described in the above-noted references.

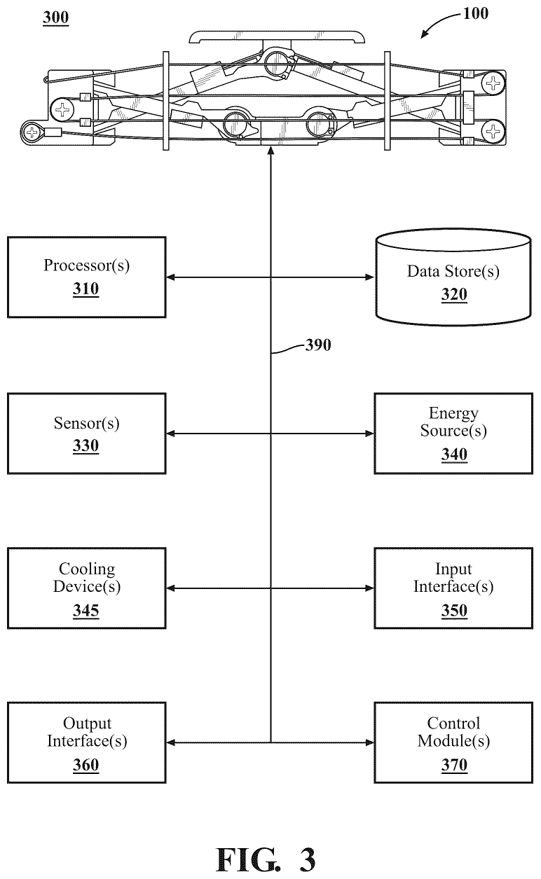

FIG. 3 shows an example of a system 300 of which the actuator 100 can be a part.

The system 300 can include various elements. Some of the possible elements of the system 300 are shown in FIG. 3 and will now be described. It will be understood that it is not necessary for the system 300 to have all of the elements shown in FIG. 3 or described herein. The system 300 can have any combination of the various elements shown in FIG. 3. Further, the system 300 can have additional elements to those shown in FIG. 3. In some arrangements, the system 300 may not include one or more of the elements shown in FIG. 3. Further, the elements shown may be physically separated by large distances.

The system 300 can include the actuator 100 as described above. The actuator 100 can be operatively connected to one or more of the elements of the system 300.

In addition to the actuator 100, the system 300 can include one or more processors 310, one or more data stores 320, one or more sensors 330, one or more energy sources 340, one or more input interfaces 350, one or more output interfaces 360, and/or one or more control modules 370. Each of these elements will be described in turn below.

As noted above, the system 300 can include one or more processors 310. “Processor” means any component or group of components that are configured to execute any of the processes described herein or any form of instructions to carry out such processes or cause such processes to be performed. The processor(s) 310 may be implemented with one or more general-purpose and/or one or more special-purpose processors. Examples of suitable processors include microprocessors, microcontrollers, DSP processors, and other circuitry that can execute software. Further examples of suitable processors include, but are not limited to, a central processing unit (CPU), an array processor, a vector processor, a digital signal processor (DSP), a field-programmable gate array (FPGA), a programmable logic array (PLA), an application specific integrated circuit (ASIC), programmable logic circuitry, and a controller. The processor(s) 310 can include at least one hardware circuit (e.g., an integrated circuit) configured to carry out instructions contained in program code. In arrangements in which there is a plurality of processors 310, such processors can work independently from each other, or one or more processors can work in combination with each other.

The system 300 can include one or more data stores 320 for storing one or more types of data. The data store(s) 320 can include volatile and/or non-volatile memory. Examples of suitable data stores 320 include RAM (Random Access Memory), flash memory, ROM (Read Only Memory), PROM (Programmable Read-Only Memory), EPROM (Erasable Programmable Read-Only Memory), EEPROM (Electrically Erasable Programmable Read-Only Memory), registers, magnetic disks, optical disks, hard drives, or any other suitable storage medium, or any combination thereof. The data store(s) 320 can be a component of the processor(s) 310, or the data store(s) 320 can be operatively connected to the processor(s) 310 for use thereby. The term “operatively connected,” as used throughout this description, can include direct or indirect connections, including connections without direct physical contact.

In some arrangements, the data store(s) 320 can store one or more actuation profiles. The actuation profile(s) can include instructions for activating and deactivating the actuators 100 in a specified manner. The actuation profile(s) can include activation patterns, activation sequences, activation times, activation of individual actuators or groups of actuators, etc. The actuation profile(s) can be created by an end user, an actuator manufacturer, a seat manufacturer, a vehicle manufacturer, or some other entity (e.g., such as a wellness or medical provider, service, or business). In some instances, one or more actuation profile(s) can be received from a remote source. In some arrangements, one or more actuation profile(s) can be associated with a particular health condition or state or context of a seat occupant.

In some arrangements, the data store(s) 320 can store information or data about the contracting member(s) 180. As an example, the data store(s) 320 can store phase transition temperature data for the contracting member(s) 180.

The system 300 can include one or more sensors 330. “Sensor” means any device, component and/or system that can detect, determine, assess, monitor, measure, quantify, acquire, and/or sense something. The one or more sensors can detect, determine, assess, monitor, measure, quantify, acquire, and/or sense in real-time. As used herein, the term “real-time” means a level of processing responsiveness that a user or system senses as sufficiently immediate for a particular process or determination to be made, or that enables the processor to keep up with some external process.

In arrangements in which the system 300 includes a plurality of sensors 330, the sensors can work independently from each other. Alternatively, two or more of the sensors can work in combination with each other. In such case, the two or more sensors can form a sensor network. The sensor(s) 330 can be operatively connected to the processor(s) 310, the data store(s) 320, and/or other elements of the system 300 (including any of the elements shown in FIG. 1).

In one or more arrangements, the sensor(s) 330 can include one or more contracting member temperature sensors. The contracting member temperature sensor(s) can be any sensor, now known or later developed, configured to detect, determine, assess, monitor, measure, quantify and/or sense the temperature of a contracting member. In some arrangements, the contracting member temperature sensor(s) may not directly detect, determine, assess, monitor, measure, quantify and/or sense the temperature of a contracting member. In such case, the contracting member temperature sensor(s) can be any sensor, now known or later developed, configured to detect, determine, assess, monitor, measure, quantify and/or sense an effect of temperature change on the contracting member, wherein the sensor is operatively connected to the processor.

In some arrangements, the sensor(s) 330 can be used to monitor the state of the contracting member and/or for position control of a contracting member. The sensor(s) 330 can include one or more sensors, now known or later developed, that can detect, determine, assess, monitor, measure, quantify, acquire, and/or sense one or more quantities (fundamental or derived) of the contracting member. The quantities can include physical, electrical, photometric, or radiometric quantities. The activation and/or deactivation of the contracting member affects the measurements by and/or the output of the sensor(s) 330. In some arrangements, the sensor(s) 330 can be configured to vary its output signal responsive to changes in the operative engagement by the contracting member. For instance, the sensor(s) 330 can convert an applied force, pressure, tension, weight, etc., into a change in some quantity of the contracting member.

Various non-limiting examples of the sensor(s) 330 will now be described. In one or more arrangements, the sensor(s) 330 can be a force sensitive resistive sensor. In one or more arrangements, the sensor(s) 330 can be a capacitive sensor. In one or more arrangements, the sensor(s) 330 can be a thermistor. In such case, the thermistor can, for example, be operatively connected to the contracting member with a spring load bump. Alternatively, the thermistor can be operatively connected to a heat pipe, which is operatively connected to the contracting member. In one or more arrangements, the sensor(s) 330 can be an infrared sensor. In one or more arrangements, the sensor(s) 330 can be a flex sensor (e.g., electro-resistive sensor). In one or more arrangements, the sensor(s) 330 can be a displacement sensor (e.g., a spring with encoded measuring). In one or more arrangements, the sensor(s) 330 can be an on/off affected switch. In one or more arrangements, the sensor(s) 330 can be a current (active or passive) sensor. In one or more arrangements, the sensor(s) 330 can be a strain gauge. In one or more arrangements, the sensor(s) 330 can be a laser sensor, which can detect distance change. In one or more arrangements, the sensor(s) 330 can be a photogate trigger. In one or more arrangements, the sensor(s) 330 can be a thermochromic indicator on wire. In one or more arrangements, the sensor(s) 330 can be a gloss monitor of wire. In one or more arrangements, the sensor(s) 330 can be a phase change pressure monitor. In one or more arrangements, the sensor(s) 330 can be a phase change volume monitor.

Some examples of sensors and arrangements for monitoring the state of a contracting member (e.g., a shape memory material member) and/or position control of a contracting member are described in U.S. patent application Ser. Nos. 18/452,602, 18/758,043, and 18/738,516, which are incorporated herein by reference in their entireties. The above example sensors can be used in connection with these disclosures.

As noted above, the system 300 can include one or more energy sources 340. The energy source(s) 340 can be any energy source capable of and/or configured to heat and/or energize the contracting member(s) 180 of the actuator 100. The energy source(s) 340 can be operatively connected or operatively positioned to supply energy to the contracting member(s) 180. In some arrangements, the energy source(s) 340 can supply electrical energy to the contracting member(s) 180. For example, the energy source(s) 340 can include one or more batteries, one or more fuel cells, one or more generators, one or more alternators, one or more solar cells, and combinations thereof. However, it will be appreciated that arrangements described herein are not limited to activating and/or deactivating the contracting member(s) 180 based on electrical energy. Indeed, as an example, the contracting member(s) 180 can be activated and/or by supplying hot air to the contracting member 180. In such case, the energy source(s) 340 can include a heater or some other heat source. The heater can be operatively positioned with respect to the contracting member(s) 180.

The system 300 can include one or more cooling devices 345 or cooling sources. The cooling devices 345 can be used to facilitate cooling of the contracting member(s) 180 below the phase transition temperature. The cooling device(s) 345 can include one or more air movement devices (e.g., a fan, blower, or duct), liquids, Peltier cooling or other thermoelectric type cooling, other types of cooling, or any combination thereof. The cooling device(s) 345 can be operatively connected to and/or operatively positioned relative to the contracting member(s) 180.

The system 300 can include one or more input interfaces 350. An “input interface” includes any device, component, system, element or arrangement or groups thereof that enable information/data to be entered into a machine. The input interface(s) 350 can receive an input from a user. Any suitable input interface 350 can be used, including, for example, a keypad, display, touch screen, multi-touch screen, button, joystick, mouse, trackball, microphone and/or combinations thereof.

The system 300 can include one or more output interfaces 360. An “output interface” includes any device, component, system, element or arrangement or groups thereof that enable information/data to be presented to a user. The output interface(s) 360 can present information/data to a user. The output interface(s) 360 can include a display, an earphone, and/or speaker. Some components of the system 300 may serve as both a component of the input interface(s) 350 and a component of the output interface(s) 360.

The system 300 can include one or more modules, at least some of which will be described herein. The modules can be implemented as computer readable program code that, when executed by a processor, implement one or more of the various processes described herein. One or more of the modules can be a component of the processor(s) 310, or one or more of the modules can be executed on and/or distributed among other processing systems to which the processor(s) 310 is operatively connected. The modules can include instructions (e.g., program logic) executable by one or more processor(s) 310. Alternatively or in addition, one or more data stores 320 may contain such instructions.

In one or more arrangements, the modules described herein can include artificial or computational intelligence elements, e.g., neural network, fuzzy logic, or other machine learning algorithms. Further, in one or more arrangements, the modules can be distributed among a plurality of modules. In one or more arrangements, two or more of the modules described herein can be combined into a single module.

The system 300 can include one or more control modules 370. The control module(s) 370 can be configured to receive signals, data, information, and/or other inputs from one or more elements of the system 300. The control module(s) 370 can be configured to analyze these signals, data, information, and/or other inputs. The control module(s) 370 can be configured to select one or more of the actuator(s) 100 to be activated or deactivated to achieve a desired effect. In some arrangements, the control module(s) 370 can be configured to select a predefined actuation profile from the data store(s) 320 to effectuate a desired actuation. Alternatively or additionally, the control module(s) 370 can be configured to detect user inputs (e.g., commands) provided on the input interface(s) 350. The control module(s) 370 can be configured to send control signals or commands over a communication network 390 to one or more elements of the system 300, including the actuator(s) 100, the contracting member(s) 180, and/or any portion thereof.

The control module(s) 370 can be configured to cause the selected one or more of the actuator(s) 100 to be activated or deactivated by activating or deactivating the respective contracting member(s) 180 associated with the selected actuator(s) 100. As used herein, “cause” or “causing” means to make, force, compel, direct, command, instruct, and/or enable an event or action to occur or at least be in a state where such event or action may occur, either in a direct or indirect manner. The control module(s) 370 can selectively provide an activation input to the actuator(s) 100 or, more particularly, to the contracting member(s) 180 associated with the selected actuator(s) 100. For example, the control module(s) 370 can selectively permit or prevent the supply of energy from the energy source(s) 340. The control module(s) 370 can be configured to do so in any suitable manner, such as automatically or autonomously based on one or more factors or real-time conditions (e.g., sensor data from the sensor(s) 330) or in response to a user input (e.g., provided on the input interface(s) 350).

The control module(s) 370 can be configured to monitor the state of the contracting member. More particularly, the control module(s) 370 can be configured to monitor the state of the contracting member during cooling to determine when a sufficiently cooled state is achieved. The state of the contracting member can be monitored in any suitable manner. Some examples are described in U.S. Pat. No. 12,234,811 and U.S. patent application Ser. Nos. 18/758,043 and 18/738,516, which are incorporated herein by reference in their entireties. The arrangements described herein can be used in connection with any of these examples. “Sufficiently cooled” can include when the values of a measured temperature of the contracting member or measured values of or an effect of temperature change on the contracting member substantially stop changing (substantially plateau). “Substantially stop changing” can be over a period of time or over a number of measurements. “Substantially stop changing” and variants thereof can include being within a predetermined number of degrees, a predetermined percentage, or a predetermined number of units. For example, “substantially stop changing” and variants thereof can include being within 10 degrees/percent/units or less, within 9 degrees/percent/units or less, within 8 degrees/percent/units or less, within 7 degrees/percent/units or less, within 6 degrees/percent/units or less, within 5 degrees/percent/units or less, within 4 degrees/percent/units or less, within 3 degrees/percent/units or less, within 2 degrees/percent/units or less, within 1 degree/percent/unit or less, or within 0.5 degree/percent/unit or less, just to name a few possibilities. The temperature of a sufficiently cooled contracting member can be greater than a fully cooled contracting member.

In one or more arrangements, the control module(s) 370 can be configured to monitor the values of an electrical characteristic of or responsive to the contracting member over time. When the measured values plateau in a cooling cycle, then it can be recognized that a sufficient cooled state of the contracting member 180 is achieved.

The control module(s) 370 can be configured to cause the contracting member(s) 180 to be actively cooled. For instance, the measured values or sensor data from monitoring the state of the contracting member 180 can be fed back into the control module(s) 370. Based on these values, the control module(s) 370 can control the on/off state of cooling fans, the speed of the cooling fans, and/or the number of cooling fans. The feedback loop can be used during the cooling process. For instance, if the wire is not cooling fast enough, then the operation of the cooling device(s) 345 can be adjusted by the controller to speed up the process. When a sufficiently cooled state of the contracting member(s) 180 is achieved, the control module(s) 370 can cause the active cooling of the contracting member(s) 180 to be discontinued or reduced (e.g., one or more cooling devices can be turned off, the speed of one or more cooling devices can be reduced, and/or a number of active cooling devices can be reduced). An example of the cooling feedback loop is shown in FIG. 5.

Further cooling can be provided by, for example, one or more fans to expedite the cooling process. The control module(s) 370 can be configured to cause the selected one or more of the actuator(s) 100 to be activated or deactivated by activating or deactivating the respective contracting member(s) 180 associated with the selected actuator(s) 100. As used herein, “cause” or “causing” means to make, force, compel, direct, command, instruct, and/or enable an event or action to occur or at least be in a state where such event or action may occur, either in a direct or indirect manner. The control module(s) 370 can selectively provide an activation input to the actuator(s) 100 or, more particularly, to the contracting member(s) 180 associated with the selected actuator(s) 100. For example, the control module(s) 370 can selectively permit or prevent the supply of energy from the energy source(s) 340. The control module(s) 370 can be configured to do so in any suitable manner, such as automatically or autonomously based on one or more factors or real-time conditions (e.g., sensor data from the sensor(s) 330) or in response to a user input (e.g., provided on the input interface(s) 350).

The various elements of the system 300 can be communicatively linked to one another or one or more other elements through one or more communication networks 390. As used herein, the term “communicatively linked” can include direct or indirect connections through a communication channel, bus, pathway or another component or system. A “communication network” means one or more components designed to transmit and/or receive information from one source to another. The data store(s) 320 and/or one or more other elements of the system 300 can include and/or execute suitable communication software, which enables the various elements to communicate with each other through the communication network and perform the functions disclosed herein.

The one or more communication networks 390 can be implemented as, or include, without limitation, a wide area network (WAN), a local area network (LAN), the Public Switched Telephone Network (PSTN), a wireless network, a mobile network, a Virtual Private Network (VPN), the Internet, a hardwired communication bus, and/or one or more intranets. The communication network further can be implemented as or include one or more wireless networks, whether short range (e.g., a local wireless network built using a Bluetooth or one of the IEEE 802 wireless communication protocols, e.g., 802.11a/b/g/i, 802.15, 802.16, 802.20, Wi-Fi Protected Access (WPA), or WPA2) or long range (e.g., a mobile, cellular, and/or satellite-based wireless network; GSM, TDMA, CDMA, WCDMA networks or the like). The communication network can include wired communication links and/or wireless communication links. The communication network can include any combination of the above networks and/or other types of networks.

As noted above, the system 300 can include additional elements to those shown in FIG. 3. For instance, the system 300 can include a cooling source or a cooling device to facilitate cooling of the contracting member(s) 180 below the phase transition temperature. The cooling source of the cooling device can include an air movement device (e.g., a fan, blower, or duct).

Now that the various potential systems, devices, elements and/or components of the system 300 have been described, various methods will now be described. Various possible steps of such methods will now be described. The methods described may be applicable to the arrangements described above, but it is understood that the methods can be carried out with other suitable systems and arrangements. Moreover, the methods may include other steps that are not shown here, and in fact, the methods are not limited to including every step shown. The blocks that are illustrated here as part of the methods are not limited to the particular chronological order. Indeed, some of the blocks may be performed in a different order than what is shown and/or at least some of the blocks shown can occur simultaneously.

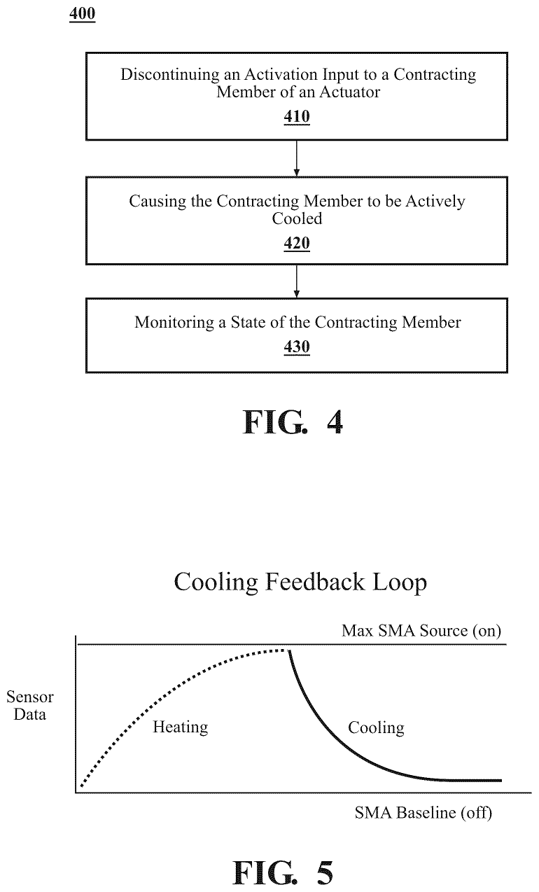

Turning to FIG. 4, an example of a method 400 is shown. The method 400 can be directed to the actuator 100. The actuator 100 can have a contracting member(s) 180 (e.g., the shape memory material member(s) 181). The contracting member(s) 180 can have an associated phase transition temperature. When an activation input (e.g., electrical energy, heat, etc.) is provided to the contracting member(s) 180, the contracting member(s) 180 can contract when its temperature rises above the phase transition temperature. As a result, the actuator 100 can morph into an activated configuration in which a dimension (e.g., height) of the actuator 100 increases.

At block 410, when the actuator 100 is in the activated configuration, the activation input to the contracting member 180 can be discontinued. Such discontinuing can be performed by the processor(s) 310 and/or the control module(s) 370. For instance, the processor(s) 310 and/or the control module(s) 370 can cause the supply of energy from the energy source(s) 340 to the actuator 100 to stop. More particularly, the processor(s) 310 and/or the control module(s) 370 can cause electrical energy from the energy source(s) 340 to be supplied to the contracting member(s) 180 (e.g., the shape memory material member(s) 181) of the actuator 100. As a result, the contracting member(s) 180 can begin to cool by heat exchange with the environment. The discontinuing can be performed automatically, in response to a user input (e.g., provided on the input interface(s) 350), or in any other suitable way. The method 400 can continue to block 420.

At block 420, the contracting member(s) 180 can be caused to be actively cooled. Active cooling includes causing one or more cooling device(s) 345 to supply cooling to be supplied to the contracting member(s) 180. For instance, the processor(s) 310 and/or the control module(s) 370 can cause an air movement device (e.g., a fan, blower, or duct) to be activated such that cooling air is directed to the contracting member(s) 180. In some arrangements, the contracting member(s) 180 can be caused to be actively cooled is performed when a rate of cooling of the contracting member(s) 180 does not meet a threshold. For instance, if the contracting member(s) 180 is not cooling fast enough by heat exchange with the environment, active cooling can be used to cool the contracting member(s) 180. The method 400 can continue to block 430.

At block 430, a state of the contracting member can be monitored. Such monitoring can be performed by the processor(s) 310, the sensor(s) 330, and/or the control module(s) 370. Any suitable type and/or manner of state monitoring can be performed, such as those disclosed in U.S. Pat. No. 12,234,811 and U.S. patent application Ser. Nos. 18/758,043 and 18/738,516, which are incorporated herein by reference in their entireties.

The method 400 can end. Alternatively, the method 400 can return to block 410 or to some other block. The method 400 can be repeated at any suitable point, such as at a suitable time or upon the occurrence of any suitable event or condition. In some instances, the method 400 can include additional blocks.

For instance, a temperature of the contracting member(s) 180 can be measured by the sensor(s) 330. Such measuring can be performed continuously, periodically, irregularly, or even randomly. The temperature of the contracting member(s) 180 can be monitored by the control module(s) 370 and/or the processor(s) 310 based on sensor data acquired by the sensor(s) 330.

Thus, it can be determined when the temperature of the contracting member(s) 180 is above or below the phase transition temperature. When a temperature of the contracting member(s) 180 falls below the phase transition temperature, the contracting member(s) 180 can begin to relax and the actuator 100 can start to return to the non-activated configuration.

Alternatively or additionally, it can be determined when a temperature of the contracting member(s) 180 or other sensor data substantially stops changing (e.g., when the sensor data plateaus). In such case, the control module(s) 370 and/or the processor(s) 310 can determine that the contracting member(s) 180 is sufficient cooled. When the contracting member(s) 180 is sufficiently cooled, the control module(s) 370 and/or the processor(s) 310 can take one or more actions. As an example, the control module(s) 370 and/or the processor(s) 310 can discontinue or reduce the active cooling of the contracting member. As another example, the control module(s) 370 and/or the processor(s) 310 can cause an activation input to be provided to the contracting member(s) 180. In such case, a heating cycle can begin.

In some arrangements, when at least one metric is fulfilled based on sensor data, the control module(s) 370 and/or the processor(s) 310 can be configured to discontinue or reduce the active cooling the contracting member.

One manner of using arrangements presented herein will now be described in connection with the state monitoring arrangements from U.S. patent application Ser. No. 18/452,602. When a contracting member of an actuator is deactivated, the contracting member can cool and relax. Cooling can be provided by heat transfer with the ambient environment. Additional cooling can be provided by, for example, one or more fans to expedite the cooling process. As a result, the squeezing of the force sensitive resistive sensor by the contracting member wrapped around the force sensitive resistive sensor can reduce. The absolute resistance does not have to be known. The change in electrical resistance of the sensor can be monitored. When the electrical resistance is no longer changing, the control module(s) 370 can recognize that the contracting member has reached an effectively cooled condition. When this point is reached, the control module(s) 370 can alter the cooling of the contracting member, such as by turning off one or more fans, reducing the speed of one or more fans, or combinations thereof. In this way, overcooling of the contracting member can be minimized.

Arrangements described herein can be used in connection with contracting member-based actuators in any application. For example, arrangements described herein can be used in connection with contracting member-based actuators used in vehicles. More particularly, arrangements described herein can be used in connection with contracting member-based actuators used in vehicle seats. Still more particularly, arrangements described herein can be used in connection with contracting member-based actuators used in vehicle seats for massaging. However, it will be appreciated that arrangements described herein can be used in connection with various non-vehicular applications.

It will be appreciated that arrangements described herein can provide numerous benefits, including one or more of the benefits mentioned herein. For example, arrangements described herein can avoid overcooling of a contracting member of an actuator. Arrangements described herein can minimize the drawing of unnecessary power. Arrangements described herein can achieve effective cooling of the contracting member, which can contribute to mix/max actuation duty cycles. Arrangements described herein can enable the active monitoring of a cooling contracting member. Arrangements described herein can preserve contracting member performance over repeat heating and cooling cycles. Arrangements described herein can reduce power consumption; in particular, the extra actuator power that is required if the contracting member is being actively overcooled but still required to actuate.

Arrangements described herein can be used in various applications in which a force is imparted on another structure or person. In some arrangements, arrangements described herein can be used in connection with a vehicle (e.g., an automobile, a watercraft, an aircraft, a hovercraft, a spacecraft, any other form of transport (including motorized or energized transport). For instance, the actuators can be located within or operatively positioned relative to a vehicle seat. For instance, arrangements described herein can be used in connection with a vehicle seat to provide a haptic, massaging, vibration, and/or other effect to an occupant of the vehicle seat. As another example, arrangements described herein can be used to adjust the position of a vehicle component. Further, it will be appreciated that arrangements described herein can be used in connection with various non-vehicular applications, such as chairs, office chairs, massage chairs, beds, etc. Still further, arrangements described herein can be used in connection with massaging devices.

The flowcharts and block diagrams in the figures illustrate the architecture, functionality, and operation of possible implementations of systems, methods and computer program products according to various embodiments. In this regard, each block in the flowcharts or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved.

The systems, components and/or processes described above can be realized in hardware or a combination of hardware and software and can be realized in a centralized fashion in one processing system or in a distributed fashion where different elements are spread across several interconnected processing systems. Any kind of processing system or other apparatus adapted for carrying out the methods described herein is suited. A typical combination of hardware and software can be a processing system with computer-usable program code that, when being loaded and executed, controls the processing system such that it carries out the methods described herein. The systems, components and/or processes also can be embedded in a computer-readable storage, such as a computer program product or other data programs storage device, readable by a machine, tangibly embodying a program of instructions executable by the machine to perform methods and processes described herein. These elements also can be embedded in an application product which comprises all the features enabling the implementation of the methods described herein and which when loaded in a processing system, is able to carry out these methods.

Furthermore, arrangements described herein may take the form of a computer program product embodied in one or more computer-readable media having computer-readable program code embodied, e.g., stored, thereon. Any combination of one or more computer-readable media may be utilized. The computer-readable medium may be a computer-readable signal medium or a computer-readable storage medium. The phrase “computer-readable storage medium” means a non-transitory storage medium. A computer-readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer-readable storage medium would include the following: an electrical connection having one or more wires, a portable computer diskette, a hard disk drive (HDD), a solid state drive (SSD), a random access memory (RAM), a read-only memory (ROM), an erasable programmable read-only memory (EPROM or Flash memory), an optical fiber, a portable compact disc read-only memory (CD-ROM), a digital versatile disc (DVD), an optical storage device, a magnetic storage device, or any suitable combination of the foregoing. In the context of this document, a computer-readable storage medium may be any tangible medium that can contain or store a program for use by or in connection with an instruction execution system, apparatus, or device.

The terms “a” and “an,” as used herein, are defined as one or more than one. The term “plurality,” as used herein, is defined as two or more than two. The term “another,” as used herein, is defined as at least a second or more. The terms “including” and/or “having,” as used herein, are defined as comprising (i.e., open language). The term “or” is intended to mean an inclusive “or” rather than an exclusive “or.” The phrase “at least one of . . . and . . . ” as used herein refers to and encompasses any and all possible combinations of one or more of the associated listed items. As an example, the phrase “at least one of A, B and C” includes A only, B only, C only, or any combination thereof (e.g., AB, AC, BC, or ABC). As used herein, the term “substantially” or “about” includes exactly the term it modifies and slight variations therefrom. Thus, the term “substantially parallel” means exactly parallel and slight variations therefrom. “Slight variations therefrom” can include within 15 degrees/percent/units or less, within 14 degrees/percent/units or less, within 13 degrees/percent/units or less, within 12 degrees/percent/units or less, within 11 degrees/percent/units or less, within 10 degrees/percent/units or less, within 9 degrees/percent/units or less, within 8 degrees/percent/units or less, within 7 degrees/percent/units or less, within 6 degrees/percent/units or less, within 5 degrees/percent/units or less, within 4 degrees/percent/units or less, within 3 degrees/percent/units or less, within 2 degrees/percent/units or less, or within 1 degree/percent/unit or less. In some instances, “substantially” can include being within normal manufacturing tolerances.

Aspects herein can be embodied in other forms without departing from the spirit or essential attributes thereof. Accordingly, reference should be made to the following claims, rather than to the foregoing specification, as indicating the scope hereof.

What is claimed is:

1. A system, comprising:
an actuator including a contracting member, when an activation input is provided to the contracting member, the actuator being configured to morph into an activated configuration in which a dimension of the actuator increases; and
a processor configured to:
when the actuator is in the activated configuration, discontinuing the activation input to the contracting member;
causing the contracting member to be actively cooled; and
monitoring a state of the contracting member.

2. The system of claim 1, further including a sensor configured to acquire or output sensor data, wherein the contracting member operatively engages the sensor, and wherein the sensor is operatively connected to the processor.

3. The system of claim 2, further including:
a sensor configured to measure a temperature of the contracting member, wherein the sensor is operatively connected to the processor, and wherein monitoring the state of the contracting member includes monitoring a temperature of the contracting member.

4. The system of claim 2, further including:
a sensor configured to detect or measure an effect of temperature change on the contracting member, wherein the sensor is operatively connected to the processor, and wherein monitoring the state of the contracting member includes monitoring an effect of temperature change on the contracting member.

5. The system of claim 2, wherein the processor is further configured to:
when the sensor data substantially stops changing, causing the active cooling of the contracting member to be discontinued.

6. The system of claim 2, wherein, when at least one metric is fulfilled based on sensor data, the processor is configured to discontinue or reduce the active cooling of the contracting member.

7. The system of claim 2, wherein the processor is configured to control the state of the contracting member using the sensor data.

8. The system of claim 1, further including one or more cooling devices operatively connected to the processor, wherein the one or more cooling devices are operatively positioned relative to the contracting member, and wherein causing the contracting member to be actively cooled includes controlling an on/off state, a speed, or a number of cooling devices.

9. The system of claim 1, wherein causing the contracting member to be actively cooled is performed when a rate of cooling of the contracting member does not meet a threshold.

10. The system of claim 1, wherein the contracting member is a shape memory material member.

11. The system of claim 10, wherein the shape memory material member is a shape memory alloy.

12. The system of claim 10, wherein the shape memory material member is a wire.

13. The system of claim 1, wherein the processor is configured to:
when the contracting member is sufficiently cooled, discontinuing or reducing the active cooling of the contracting member.

14. A method, an actuator includes a contracting member, when an activation input is provided to the contracting member, the actuator being configured to morph into an activated configuration in which a dimension of the actuator increases, the method comprising:
when the actuator is in an activated configuration, discontinuing an activation input to the contracting member;
causing the contracting member to be actively cooled; and
monitoring a state of the contracting member.

15. The method of claim 14, wherein monitoring a state of the contracting member includes monitoring a temperature of the contracting member.

16. The method of claim 14, wherein monitoring the state of the contracting member includes monitoring an effect of temperature change on the contracting member.

17. The method of claim 14, wherein the method further includes:
when the contracting member is sufficiently cooled, discontinuing the active cooling of the contracting member.

18. The method of claim 14, wherein the method further includes:
when sensor data acquired or output by a sensor operatively connected to the contracting member substantially stops changing, causing the active cooling of the contracting member to be discontinued or reduced.

19. The method of claim 14, wherein the method further includes:
when at least one metric is fulfilled based on sensor data acquired or output by sensor operatively connected to the contracting member, discontinuing or reducing the active cooling the contracting member.

20. The method of claim 14, wherein causing the contracting member to be actively cooled includes controlling an on/off state, a speed, or a number of one or more cooling devices operatively positioned relative to the contracting member.

21. The method of claim 14, wherein causing the contracting member to be actively cooled is performed when a rate of cooling of the contracting member does not meet a threshold.
